(19) United States
(12) Patent Application Publication
(10) Pub. No.: US 2023/0032745 A1
(43) Pub. Date: Feb. 2, 2023

(54) MATING AND DEMATING OF SURFACES OF TWO STRUCTURES

(71) Applicants: FUNDACIÓN TECNALIA RESEARCH & INNOVATION, San Sebastián (ES); BCAM Basque Center for Applied Mathematics, Bilbao (ES)

(72) Inventors: Joannes BERQUE, San Sebastián (ES); Antonio Rico Rubio, San Sebastián (ES); Jan SELLNER, San Sebastián (ES); Vincenzo NAVA, Bilbao (ES); José Luis VILLATE MARTÍNEZ, San Sebastián (ES)

(21) Appl. No.: 17/758,865

(22) PCT Filed: Jan. 15, 2021
(86) PCT No.: PCT/EP2021/050830

§ 371 Date: Jul. 14, 2022

(30) Foreign Application Priority Data
Jan. 16, 2020 (EP) 20382025.3

(51) Int. Cl. F03D 13/10; F03D 1/06; F03D 13/20

(52) U.S. Cl. CPC F03D 13/10; F03D 1/0658; F03D 1/0675; F03D 13/20; F05B 2230/608; F05B 2240/302; F05B 2240/912

(57) ABSTRACT

A method for mating a first surface of a first structure to a second surface of a second structure, the method comprising: providing a device at least comprising: a first body adapted for insertion at least in a through hole of the first surface; and a second body adapted for insertion at least in a through hole of the second surface, the first body being further adapted for being mechanically coupled with a second body, and the second body being mechanically coupled with the first body; inserting at least a first portion of the first body in the through hole of the first surface; inserting the second body in the through hole of the second surface when the first and second surfaces are spaced apart by a distance; providing an apparatus for winding the second body; arranging the second body on the apparatus; and pulling one of the first and second structures towards the other one of the first and second structures by winding the second body with the apparatus.

### TECHNICAL FIELD

The present invention relates to the technical field of structure mating and/or demating. More particularly, the present invention relates to methods and devices for mating surfaces of two structures and/or for demating the surfaces of the two structures.

### STATE OF THE ART

The construction of buildings oftentimes requires the mating of surfaces of several structures that will ultimately form the buildings, especially when the buildings are towers, skyscrapers, wind turbines, dams, etc. The mass of such structures may be in the order of tens, hundreds or even thousands of tons.

In order to mate surfaces of structures of this kind, machinery like cranes may be necessary to lift and/or align the surfaces of the structures so that mating may be effected. The presence of personnel during these tasks is usually needed for assisting in the alignment of the surfaces, not only to provide guidance to the operators of the cranes, but also to push or pull the structures for complete alignment of the structures and the surfaces thereof.

Owing to the weight and dimensions of the structures, these tasks entail complexity and risk for human life as the structures may fall down if not properly aligned, and/or the personnel can be hit by the structures during the operation.

This problem is further exacerbated when the one of the structures is to be placed above the other, for instance in order to build a dam, or a wind turbine, to name a few examples. In these cases, at least the structure above is suspended from the crane, thereby moving in accordance with the motion of the boom of the crane, but also moving in accordance with the meteorological conditions. Wind makes the alignment and posterior mating of the surfaces of the structures particularly complex as it moves the suspended structure in unpredictable ways and endangers the life of the personnel, even if the wind loads are usually in the range of 1 kN or less. Poor visual conditions due to lifted sand, clouds, fog, etc. also difficult the operation.

In addition to the above, in many occasions the cranes have a limited range of action whereby they are not capable of completing the approximation of the structures due to the way in which they have the structure attached thereto; tools for holding structures may get in the way between the two structures.

Likewise, in procedures for the demating of surfaces of two structures, similar problems may exist, including how to attach the structure to the crane so that it may be lifted or moved away from the other structure. Personnel may again be necessary during these tasks for effecting the demating.

There is an interest in providing ways to mate and/or demate respective surfaces of two structures that may simplify the procedures known in the art and alleviate or solve some of the above problems.

### DESCRIPTION OF THE INVENTION

A first aspect of the invention relates to a method for mating a first surface of a first structure to a second surface of a second structure, each of the first and second surfaces having a through hole formed therein for receiving a bolt or a guiding pin, the method comprising:

providing a device at least comprising:
a first body adapted for insertion at least in the through hole of the first surface; and
a second body adapted for insertion at least in the through hole of the second surface, the first body being further adapted for being mechanically coupled with a second body, and the second body being mechanically coupled with the first body;

inserting at least a first portion of the first body of the device in the through hole of the first surface;

inserting the second body of the device in the through hole of the second surface when the first and second surfaces are spaced apart by a distance;

providing an apparatus for winding the second body;

arranging the second body on the apparatus; and

pulling one of the first and second structures towards the other one of the first and second structures by winding the second body with the apparatus while:
the first body is at least inserted in the through hole of the first surface;
the second body is at least inserted in the through hole of the second surface; and
the first and second surfaces are spaced apart.

By way of the present method, the surfaces of the two structures can be pulled come mated owing to the use of both the device and the apparatus. The method alleviates the pulling or pushing force that personnel or auxiliary machinery (such as e.g. cranes, etc.) has to apply to one of the structures during the mating process in order to align the two structures for the mating.

Each of the first and the second surfaces usually includes a plurality of through holes, and fastening devices (e.g. bolted joints, guiding pins, etc.) may be provided between one through hole of the plurality of through holes of the first surface and one through hole of the plurality of through holes of the second surface; accordingly, a plurality of fastening devices may be used to attach one structure to the other.

When the first body is inserted in the through hole of the first surface and the second body is inserted in the through hole of the second surface, both provide a mechanism for both stabilizing at least one of the two structures and aligning the two surfaces thereof (particularly, the respective through holes are to become aligned). By pulling from the second body, at least one of the two structures can be moved towards the other structure so that the two surfaces have the respective through hole or through holes aligned.

The second body is woundable on the apparatus, e.g. a winch that has a drum around which the second body is to be wound, to this end the second body is preferably flexible. The second body is elongated, meaning that a length thereof is greater than the thickness or width thereof; as more elongated the second body is, the greater a distance between the first and second surfaces that may exist prior to the mating procedure as the second body guides one or both structures during the procedure. By way of example, the second body can be a cable, a rope or a chain, and can be made out of e.g. steel, nylon, aramid, etc.

Upon winding the second body, owing to the pulling force that the first body applies to the first structure, both the first and the second structures get closer and, at the same time, any existing misalignments between the respective through holes is progressively reduced until the distance between the surfaces becomes zero (or almost zero) and the through holes become aligned. In this respect, the step of winding may be carried out further while the through holes of the first and second surfaces are not aligned.

In the context of the present disclosure, the first and second surfaces are surfaces of structures intended to be mated by way of fastening devices, for example but without limitation, bolted joints or guiding pins. In this sense, each of the first and second surfaces is preferably a flange that incorporates a plurality of through holes intended to be aligned with the plurality of through holes of the other surface.

In some embodiments, the method further comprises attaching the apparatus to the second structure prior to the pulling step, and preferably also prior to the step of arranging the second body on the apparatus. In some other embodiments, the method further comprises attaching the apparatus to a foundation or a structural member of the second structure prior to the pulling step, and preferably also prior to the step of arranging the second body on the apparatus.

In some embodiments, the method further comprises: removing the second body from the second surface after the pulling step; and providing a fastening device after the step of withdrawing and when both the first and second surfaces are not spaced apart and the through holes thereof are aligned.

The second body can be withdrawn, for instance, by removing the second body from the apparatus (i.e. any wound part of the second body is unwound so that the second body can be withdrawn therefrom), and then extracting the second body by pulling from it. When only the second body is withdrawn, then the first body could for instance be used as a bolted joint if a nut is arranged on the first body, and said first body has a thread formed thereon.

Also, in the embodiments in which the apparatus has been attached to the second structure, the apparatus may be left attached to the second structure and, in the event that the surfaces are demated and mated again later on, the same apparatus can be used once again with the device for the mating procedure.

In some of these embodiments, the removing step further comprises removing the first body from the first surface.

The device can be withdrawn, for instance, by removing the second body from the apparatus (i.e. any wound part of the second body is unwound so that the second body can be withdrawn therefrom), and then extracting the device by pulling from the first body. Hence, the second body is first withdrawn from the through hole of the second surface, and then from the through hole of the first surface, and also the first body is withdrawn from the through hole of the first surface (and from the through hole of the second surface if it was inserted therein as well). Alternatively, the first and second bodies can be decoupled and each body removed afterwards.

Upon removing the device from the respective through holes, the fastening device can be provided for attaching the first surface to the second surface.

In some embodiments, the first body is shaped such that it cannot be entirely pulled through the through hole of the first surface (where the first body is inserted in). In these embodiments, the first body cannot be entirely pulled in a direction of insertion of the first body in the through hole of the first surface.

A second portion of the first body is adapted to not fit through the through hole of the first surface, thereby not making possible to completely introduce the first body in the through hole as the second portion is blocked by the surface where the through hole is formed.

The second portion simplifies the mating procedure since the winding of the second body pulls the first body, and as a result the first body pulls the first structure towards the second structure as the second portion cannot be entirely pulled through the through hole of the first surface.

In some embodiments, the first portion has a thread formed thereon, and the through hole of the first surface has a thread formed thereon.

The first body is screwed inside the through hole by means of the matching threads. The cooperation of the threads keeps the first body (or at least the first portion thereof) inserted in the through hole, thereby providing a fixed attachment. When the second body is wound, owing to this attachment the first structure is pulled towards the second structure, and as a result the winding reduces the distance between both structures and aligns the through holes thereof if they were misaligned.

Oftentimes, the through holes of both the first surface and the second surface have threads formed thereon (i.e. are tapped through holes) so that a fastening device (e.g. bolted joint) secures both structures, so said threads are used for the fixed attachment between the device and the tapped through hole of the first surface.

Further, in some embodiments, the method comprises arranging a nut on the first body so as to provide a bolted joint. Thanks to the thread formed, the first body can also be used as a bolted joint for mating the two surfaces, thus the first body needs not be replaced by a bolted joint. Accordingly, at least the first portion of the first body is inserted in the through hole of the second surface also (once the second body has been withdrawn therefrom), and a nut is arranged, thereby providing a bolted joint.

In some embodiments, the device further comprises means for mechanically coupling the first body with the first surface, or for mechanically coupling the second body with the second surface.

The means keep the first body attached to the first surface once at least the first portion of the first body is inserted in the through hole, or the second body attached to the second surface once at least the second body is inserted in the through hole. Due to this attachment, when the second body pulls the first body, the first structure moves towards the second structure.

In some embodiments, the means for mechanically coupling the first body with the first surface or the second body with the second surface are one or more expanding bodies at least arranged on a perimeter of the first portion or the second body, the one or more expanding bodies being adapted to expand so as to exert a compressing force between the through hole of the first surface and at least the first portion of the device or between the through hole of the second surface and the second body. In some of these embodiments, the one or more bodies are made of, or have on an outer surface thereof, a high friction material, e.g. a material having a friction coefficient of 0.8 or more.

The one or more expanding bodies, once expanded, block relative motion either between the first body and the through hole of the first surface or between the second body and the through hole of the second surface, thereby keeping either the first body (at least the first portion thereof) reliably inserted within the through hole of the first surface or the second body reliably inserted within the through hole of the second surface. When the second body pulls the first body, the first body simultaneously pulls the first structure towards the second structure.

Expanding means such as a hydraulic system actuate the body or bodies for expansion thereof so as to mechanically couple at least the first portion or the second body with the through hole. If the through hole of a part of a wind turbine is considered, expanding the body or bodies with a pressure of 20 or more bars, e.g. 30 bars, 50 bars, etc. can be enough to provide a tight compressive force able to hold the first body or the second body during the mating operation.

By way of example, the body or bodies can be made of rubber, which when contacting a steel surface (for instance the first portion of the first body is made of steel in some embodiments) result in a friction coefficient of about 1.0.

In some embodiments, the means for mechanically coupling the first body with the first surface or the second body with the second surface are adhesive arranged at least on a perimeter of the first portion or the second body.

In some embodiments, the method further comprises mechanically coupling the first body with the second body prior to both inserting steps (i.e. when both the first body and the second body have not been inserted in the respective through holes of the first and second surfaces yet). In some other embodiments, the method further comprises mechanically coupling the first body with the second body after both inserting steps (i.e. when both the first body and the second body are inserted in the respective through holes of the first and second surfaces), but prior to the pulling step.

Mechanically coupling both bodies prior to the insertion thereof simplifies the mating procedure as then the device must simply be introduced through both through holes and arranged on the apparatus, whereas coupling them after the inserting steps is usually more cumbersome. Concerning the latter, each body is inserted in the respective through hole independently from the other, and then one is mechanically coupled to the other so as to form the device for mating the surfaces.

In some embodiments, the first structure or the second structure is suspended from a machine, e.g. a crane. In these embodiments, the suspended structure (either the first structure or the second structure) is at least suspended during one or more of the following steps: inserting at least the first portion of the first body in the through hole of the first surface; inserting the second body in the through hole of the second surface; arranging the second body on the apparatus; and pulling one of the first and second structures towards the other one of the first and second structures.

In some embodiments, the first surface is above (according to a vertical direction) the second surface once mated. In some other embodiments, the first surface is beneath (according to a vertical direction) the first surface once mated.

In some embodiments, the first surface is at a same height (according to a vertical direction) than the second surface once mated.

In some embodiments, each of the first and second structures is a part of a tower of a wind turbine. In some of these embodiments, one of said parts is a nacelle of a wind turbine. In some other of these embodiments, the first structure is a rotor blade of a wind turbine and the second structure is a hub of a wind turbine.

The mating of a surface of a rotor blade (the surface being a blade root thereof) and a surface of a hub of a wind turbine is also a particularly complex operation, even if one part is not above the other during the mating. The mating procedure in this situation involves lifting the rotor blade, e.g. suspending it with a crane, and moving it horizontally towards the hub for effecting the mating. Both the horizontal movement (which furthermore is in two dimensions) and the vertical movement need to be performed carefully in order to attain alignment between the respective through holes; performing these movements is not simple due to weight and dimensions of both structures, and meteorological conditions.

Notwithstanding, the present method eases the mating of the surfaces of the rotor blade and the hub.

As known in the art, the hub may comprise pitch bearings for attachment of a rotor blade thereto.

In some embodiments, each of the first structure and the second structure are structures of an offshore building, e.g. an offshore wind turbine.

In some embodiments, each of the first and second surfaces has a plurality of through holes formed therein for receiving a bolt or a guiding pin, and the method further comprises: providing a plurality of the devices; inserting each device of the plurality of the devices in a different through hole of both the first and second surfaces; attaching, to the second structure, a plurality of apparatus for winding the second body of a device of the plurality of devices; arranging the second body of each device of the plurality of devices on a different apparatus of the plurality of apparatuses; and winding the second body of each device of the plurality of devices while the device is inserted in respective through holes of both the first surface and the second surface and while the first and second surfaces are spaced apart.

The mating procedure may be simplified by providing a plurality of the devices and pulling the second bodies thereof in order to move the first structure towards the second structure, especially when the mass of at least one of the structures is greater than one or more tons, e.g. more than 10 tons, more than 100 tons, more than 1000 tons, etc., and the dimensions of the structures make difficult the mating with just one device.

In this sense, by having multiple devices with which the mating procedure is carried out, fewer operators may be necessary while the operation lasts, and also the operation becomes safer as the operators have to withstand less loads, not to mention that they have to assist less in the guiding of the structures for alignment of the through holes thereof.

Preferably, at least one such device is provided per each 50 tons of mass of the first structure or the second structure, and more preferably at least one such device per each 25 tons of mass of the first structure or second structure.

In some embodiments, the device further comprises the apparatus.

In some embodiments, the first body is a metallic body, made of e.g. steel, or a composite with strength sufficient for supporting loads during the mating procedure.

The metallic or composite body is capable of withstanding the loads during the mating procedure. Also, when the device comprises means for mechanically coupling the first body with the first surface, a metallic or composite body may support the loads applied by said means to the first body.

A second aspect of the invention relates to a device for mating a first surface of a first structure to a second surface of a second structure, the device comprising: a first body at least having a first portion adapted for insertion in a through hole of the first surface for receiving a bolt or a guiding pin; a second body adapted for insertion in a through hole of the second surface for receiving a bolt or a guiding pin, the second body being mechanically coupled with the first body; and an apparatus for winding the second body, the apparatus being adapted for attachment to the second surface.

The device makes possible to carry out a mating procedure as described above. To this end, the device comprises a first body whereby the first structure can be pulled towards the second structure, thereby reducing the distance between the two and aligning the through holes thereof if misaligned. When the apparatus, e.g. a winch having a drum where the second body can be wound on, winds the second body, the second body pulls the first body owing to its mechanical coupling with the first body.

The device is preferably a device as described with reference to the first aspect of the invention, thus, in different embodiments of the device, said device comprises the features described in the first aspect of the invention.

In some embodiments, both the first and second structures are parts of a tower of a wind turbine, or the first structure is a rotor blade of a wind turbine and the second structure is a hub of a wind turbine.

Same advantages as those described with reference to the first aspect of the invention are also applicable to this aspect of the invention.

A third aspect of the invention relates to a method for at least one of mating a first surface of a first structure to a second surface of a second structure, and demating the first surface from the second surface, each of the first and second surfaces having a through hole formed therein for receiving a bolt or a guiding pin, the method comprising:

providing a device at least comprising:
a first body adapted for insertion in the through hole of the first surface, the first body being elongated and having a thread formed thereon;
a second body adapted for insertion in the through hole of the second surface and further having a through hole adapted for receiving the first body, the through hole having a thread formed thereon; and
means for mechanically coupling the first body with the first surface such that the first body is rotatable with respect to the first surface; inserting the first body of the device in the through hole of the first surface; mechanically coupling the first body with the first surface;

inserting the second body of the device in the through hole of the second surface;

inserting the first body of the device in the second body so as to form a screw mechanism in which the first body is a screw of the screw mechanism and the second body is a nut of the screw mechanism; and

rotating the first body of the device so as to either reduce a distance between the first and second surfaces, or space apart the first and second surfaces, the first body being rotated while being both inserted in the second body and mechanically coupled with the first surface.

Mating and demating of respective surfaces of two structures can be carried out with the present method. In this respect, upon inserting the device in the through holes, in order to mate the two surfaces the first body of the device is rotated so as to reduce the distance spacing apart both structures, whereas in order to demate them the first body of the device is rotated so as to provide (if there is none) and/or increase the distance spacing apart both structures.

The device is capable of supporting at least part of the weight of the first structure and move it relative to the second structure in order to increase or reduce the distance between them. In this sense, the load to be supported by the device is the weight and not dynamic loads, that is to say, if the first and second structures belong to, for example, a wind turbine, the wind turbine is not active. Nowadays, bolts that are commonly used in wind turbines, also in offshore wind turbines, are designed to support loads that are greater than the weight of the components of the wind turbines; some such bolts are capable of supporting the weight of mass of 150 tons or even more, e.g. 250 tons.

This method is preferably applied to structures where loads in operation are significantly larger than those of the weights of the structures. This is the case, for example, for most wind turbines, where the design of bolts and bolt holes is only marginally impacted by structural weight (dead load) and instead governed by loads in operation, e.g. at turbine maximum thrust or during storms, which are typically several times higher than dead loads. This is the basic reason why most of the weight of the structure can be supported using only part of the bolt holes, at least during installation in good weather.

As the device is insertable in the through holes of the two surfaces, each of which typically includes respective plurality of such through holes for providing a number of fastening devices for securing one structure to the other, the difficulty of cranes not being capable of securely attaching to one of the structures when there is no distance between both structures is tackled. By way of example, climbing cranes usually face this problem, which can be solved thanks to this method as the device advantageously uses the through holes provided for mating structures to mate and/or demate the surfaces.

Owing to the means for mechanically coupling the first body with the first surface, the device both supports at least part of the weight of the first structure and mates/demates the surfaces of the structures without risk of the device getting out from the through holes.

In some embodiments, the method further comprises withdrawing a fastening device from the respective through hole of the first and second surfaces prior to all the inserting steps and the fastening device being withdrawn while the first and second surfaces are not spaced apart; and the first body of the device is rotated so as to space apart the first and second surfaces.

Whenever demating is to be effected, a fastening device present within the through holes of the surfaces can be removed, and then the device is inserted in the available through holes in order to carry out the demating procedure.

In some embodiments, the first body of the device is rotated so as to reduce the distance, thereby allowing to mate the two surfaces.

In some embodiments, the step of rotating the first body reduces the distance between the first and second surfaces. Further, in these embodiments, the method comprises: withdrawing the device from the first and second surfaces after the rotating step; and providing a fastening device after the step of withdrawing.

Once the surfaces have come into contact, the device can be withdrawn as the at least part of the weight of the first structure supported by the device is supported by either the second structure (which could be beneath the first structure with respect to a vertical direction), or by a ground or floor (yet the two surfaces are in contact). After withdrawing the device, the through holes are freed from said device, thereby allowing to introduce a bolt or guiding pin for securing one structure to the other.

In some embodiments, the means for mechanically coupling the first body with the first surface such that the first body is rotatable with respect to the first surface are a ball bearing or a rollers' mechanism adapted for insertion of at least a portion thereof in the through hole of the first surface.

The ball bearing or rollers' mechanism enables the rotation of the first body. At the same time, the ball bearing or rollers' mechanism remains fixedly attached within the through hole of the first surface, thus in turn coupling the first body with the first surface. Both the ball bearing and the rollers' mechanism are adapted for reducing friction, thereby easing or allowing free rotation of the first body.

In some embodiments, the first structure is suspended from a machine, e.g. a crane. In some of these embodiments, the first structure is at least suspended during the steps of: inserting the first body in the through hole of the first surface; mechanically coupling the device with the first surface; inserting the second body in the through hole of the second surface; inserting the first body in the second body so as to form the screw mechanism; and rotating the first body so as to reduce the distance between the first and second surfaces.

In some embodiments, the first surface is above (according to a vertical direction) the second surface once mated or before demating.

In some embodiments, each of the first structure and the second structure are structures of an offshore building, e.g. an offshore wind turbine.

In some embodiments, each of the first and second surfaces has a plurality of through holes formed therein for receiving a bolt or a guiding pin, and the method further comprises: providing a plurality of the devices; inserting each device of the plurality of the devices in a different through hole of both the first and second surfaces, and such that a screw mechanism is formed in which the first body of the device is the screw and the second body is the nut; mechanically coupling each device of the plurality of devices with the first surface; and rotating the first body of each device so as to either reduce the distance between the first and second surfaces, or space apart the first and second surfaces, the first body being rotated while being both inserted in the second body and mechanically coupled with the first surface.

When a single device is not capable of supporting the entire weight of the first structure, a number of devices may be arranged in order to cope with such weight. This number should be such that the load transferred via each device to the hole to which it couples mechanically stays below the load which the holeis designed to withstand (and, optionally, the load that a bolt to be inserted in the hole afterwards is designed to withstand). For example, in the case of a bolted joint at a base of a wind turbine tower, this may be several tons or up to ten or more tons per hole. This may be less in the bolted joints between the nacelle and the tower, or between a blade and its pitch bearing.

Additionally or alternatively, a single device may not be capable of maintaining the first structure in a stable way even if the weight can be supported by the device. For example, if the through holes are arranged outside of a center-most part of the surfaces, the weight of the respective structure throughout the surface thereof may result in the application of a moment whereby the structure tends to rotate. In that case, the mating of the two surfaces becomes more complex. Likewise, the demating may also be affected by this problem.

Each device may be capable of supporting 10 tons or more (e.g. 20 tons or more), and 100 tons or less (e.g. 75 tons or less, 50 tons or less, 25 tons or less). Accordingly, the plurality of devices at least includes a number of devices equal to or greater than mass of the first structure divided by nominal mass to be supported per device. By way of example, if each device nominally supports 10 tons, and the first structure has a mass of 250 tons, then 25 or more such devices would have to be arranged in different through holes of both the first and second surfaces.

In some embodiments, each of the first and second structures is a part of a tower of a wind turbine, one of said parts optionally being a nacelle of a wind turbine.

A fourth aspect of the invention relates to a device for at least one of mating a first surface of a first structure to a second surface of a second structure, and demating the first surface from the second surface, the device comprising: a first body adapted for insertion in a through hole of the first surface for receiving a bolt or a guiding pin, the first body being elongated and having a thread formed thereon;

a second body adapted for insertion in a through hole of the second surface for receiving a bolt or a guiding pin, and further having a through hole adapted for receiving the first body, the through hole having a thread formed thereon; and means for mechanically coupling the first body with the first surface such that the first body is rotatable with respect to the first surface;

the first body of the device is introduced in the second body so as to form a screw mechanism in which the first body is a screw of the screw mechanism and the second body is a nut of the screw mechanism, the screw mechanism allowing rotation of the first body of the device so as to either reduce a distance between the first and second surfaces, or space apart the first and second surfaces.

The device makes possible to carry out a mating and/or demating procedure as described with reference to the third aspect of the invention. To this end, the device comprises a first body whereby the first body is rotatable and, thus, increase or reduce the distance between the two surfaces.

The device is preferably a device as described with reference to the third aspect of the invention, thus, in different embodiments of the device, said device comprises the features described in the third aspect of the invention.

In some embodiments, each of the first and second structures is a part of a tower of a wind turbine, one of said parts optionally being a nacelle of a wind turbine.

Same advantages as those described with reference to the third aspect of the invention may also be applicable to this aspect of the invention.

A fifth aspect of the invention relates to an assembly comprising: a device according to the second aspect of the invention; the first structure; and the second structure.

In some embodiments, both the first and second structures are parts of a tower of a wind turbine, or the first structure is a rotor blade of a wind turbine and the second structure is a hub of a wind turbine.

A sixth aspect of the invention relates to an assembly comprising: a device according to the fourth aspect of the invention; the first structure; and the second structure.

In some embodiments, both the first and second structures are parts of a tower of a wind turbine, or the first structure is a rotor blade of a wind turbine and the second structure is a hub of a wind turbine. In some embodiments, each of the first and second structures is a part of a tower of a wind turbine, one of said parts optionally being a nacelle of a wind turbine.

### BRIEF DESCRIPTION OF THE DRAWINGS

To complete the description and in order to provide for a better understanding of the invention, a set of drawings is provided. Said drawings form an integral part of the description and illustrate embodiments of the invention, which should not be interpreted as restricting the scope of the invention, but just as examples of how the invention can be carried out. The drawings comprise the following figures:

FIG. 1 shows mating of parts of a tower of a wind turbine in accordance with an embodiment.

FIGS. 2A-2B and 3 show devices for mating the surfaces of two structures in accordance with embodiments.

FIGS. 4A-4D show a device and a method for mating the surfaces of two structures in accordance with embodiments.

FIGS. 5 and 6A-6C show mating of blades to wind towers in accordance with embodiments.

FIGS. 7A and 7B shows a device for mating and/or demating the surfaces of two structures in accordance with an embodiment.

FIGS. 8A-8G show a method for mating the surfaces of two structures in accordance with an embodiment.

### DESCRIPTION OF WAYS OF CARRYING OUT THE INVENTION

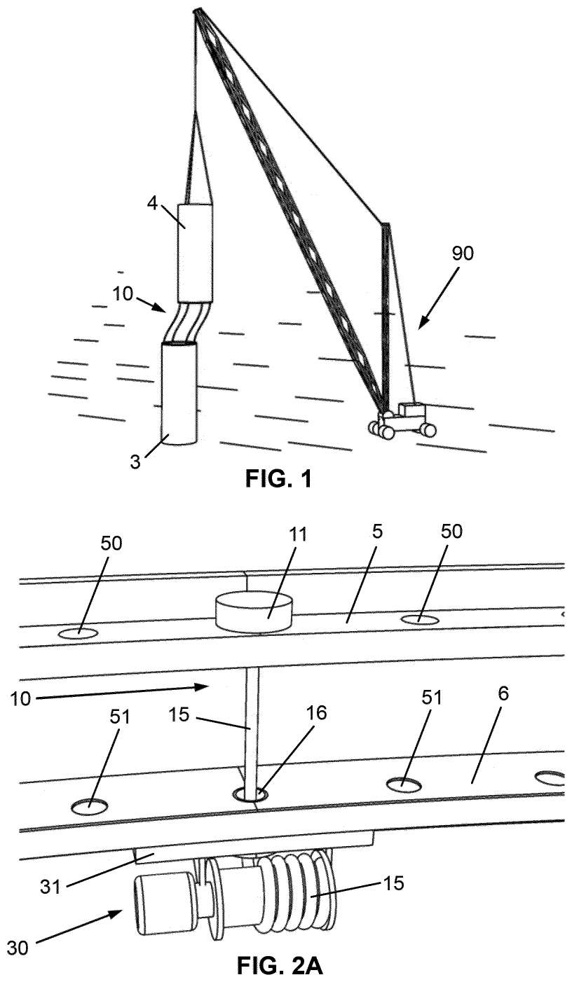

FIG. 1 shows mating of parts 3, 4 of a tower of a wind turbine in accordance with an embodiment.

A first part 3 of the tower mounted on ground and securely attached thereto by means of a foundation (not illustrated). A second part 4 of the tower is to be arranged on top of the first part 3 and mated thereto so as to erect the tower. The second part 4 is suspended from the boom of a crane 90 that lifts the second part 4 above the first part 3, and by way of a plurality of devices 10, which will be described next, the second part 4 is to be aligned with the first part 3 so that surfaces thereof can be mated.

The devices 10 assist in both moving the second part 4 for alignment thereof with respect to the first part 3, and reducing the distance spacing apart the two parts 3, 4 until the second part 4 rests on top of the first part 3, at which point the second part 4 can be released from the means of the crane to lift it and having it suspended.

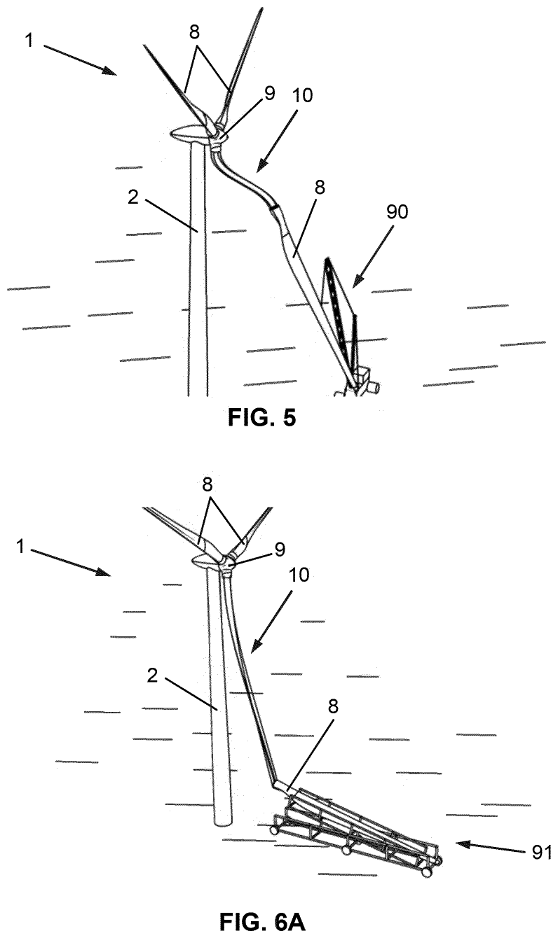

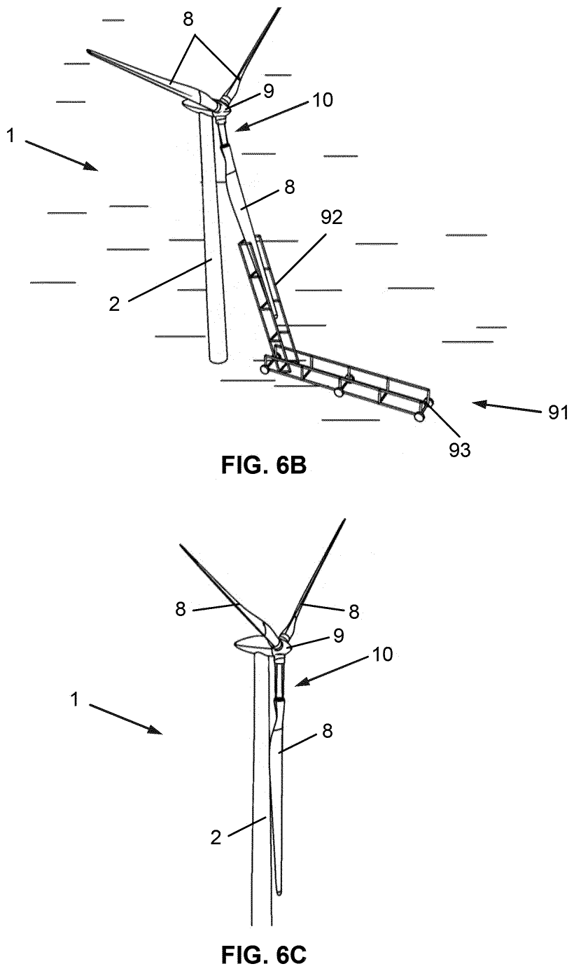

Upon erecting the different parts of the tower, a tower 2 as illustrated in FIGS. 5 and 6A-6C is provided.

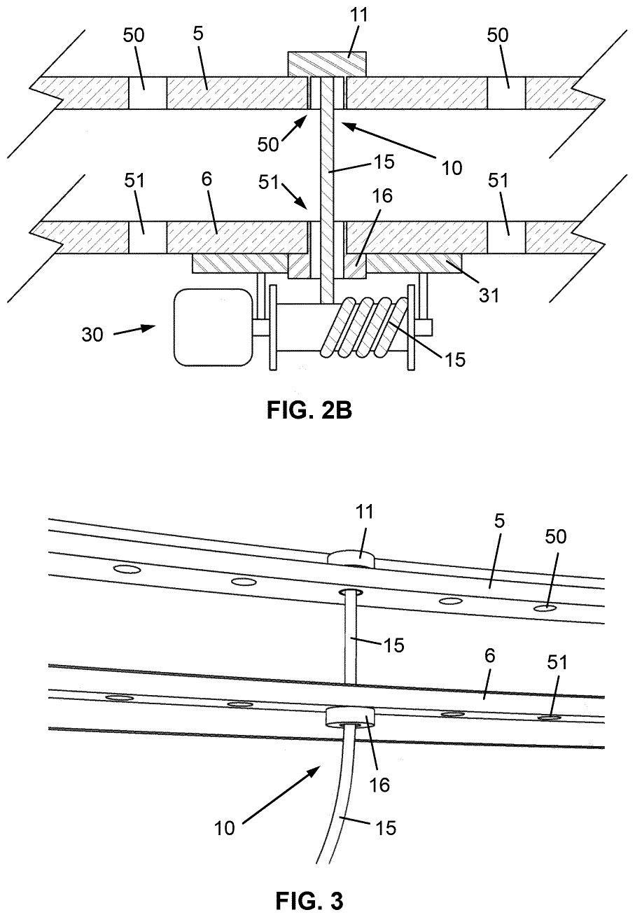

FIGS. 2A-2B show a device 10 for mating the surfaces of two structures in accordance with an embodiment. The two structures may be, for instance but without limitation, two parts of a tower of a wind turbine (such as the one of FIG. 1), including an offshore wind turbine, whereas the surfaces 5, 6 thereof to be mated are tower flanges.

The device 10 comprises a first body 11 and a second body 15; the first body 11 is adapted to be mechanically coupled with the second body 15. As best seen in FIG. 2B, the first body 11 has a portion thereof inserted in one through hole 50 of the plurality of through holes 50 of a first surface 5, which is part of a first structure. The second body 15, which is mechanically coupled with the first body 11 (preferably, an end of the second body 15 is attached to the first body 11, as in this example) is inserted in a through hole 51 of the plurality of through holes 51 of a second surface 6, which is part of a second structure. For the sake of clarity only, the through hole 50 where the first body 11 is inserted in will be hereinafter referred to as first hole 50, whereas the through hole 51 where the second body 15 is inserted in will be hereinafter referred to as second hole 51. Even though only part of the surfaces 5, 6 has been illustrated, they are flanges with respective through holes 50, 51 intended to be aligned ones with respect to the others for arranging fastening devices in each corresponding pair of through holes 50, 51.

In this embodiment, the second body 15 is further inserted in the first hole 50; in other embodiments in which the first body 11 completely fills the first hole 50, the second body 15 is not inserted in the first hole 50 but only in the second hole 51.

An apparatus 30 for winding the second body 15 is also provided for mating the two surfaces 5, 6; in this embodiment, the apparatus 30 is a winch. In this embodiment, the apparatus 30 has been attached to the second structure, and more particularly to the second surface 6 (from a face thereof not to be mated). In order to ease the attachment of the apparatus 30 to the second surface 6, a support 31 is arranged between the apparatus 30 and the second surface 6; the support 31 is e.g. a supporting plate.

The second body 15 is woundable on a drum of the winch 30 and, as shown in FIGS. 2A-2B, a portion of the second body 15 is wound on the drum. As seen in both FIGS. 2A-2B, the second body 15 is elongated. Accordingly, in a situation such as the one depicted in FIG. 1, the structures are pulled such that one of the structures moves towards the other one of the structures; this is achieved by winding the second body 15 with the apparatus 30. By winding the second body 15, the second body 15 pulls the first body 11 towards the apparatus 30, which in turn pulls the first surface 5 (and, thus, the first structure) towards the second surface 6 (and, thus, towards the second structure).

The first body 11 pulls the first surface 5 thanks to its coupling with the surface 5, which in this case is due to the shape of a portion of the first body 11 that cannot be entirely pulled through the through hole 50 of the first surface 5. In other embodiments, the first body is mechanically coupled with the first surface 5 with other means.

The device 10 preferably also comprises a third body 16 through which the second body 15 passes. The third body 16 is adapted for being inserted, at least partially, in the second hole 51 so that the second body 15 does not collide with the second hole 51, something that results in friction and, hence, mechanical stresses and erosion in the second body. In some embodiments, the third body 16 and the support 31 are integrally formed, i.e. both are formed as a single piece.

One or some other through holes 50, 51 of the first and second surfaces 5, 6 can be used for arranging further devices 10, for example, thereby distributing the load among the different devices whenever one of the structures is pulled towards the other.

FIG. 3 shows a device 10 for mating the surfaces 5, 6 (i.e. flanges) of two structures in accordance with an embodiment.

The device 10 of this embodiment is similar to the one described with reference to FIGS. 2A-2B, but in this embodiment the apparatus 30 is arranged on a foundation of the second structure 6 or in a structural member of the second structure 6, e.g. a girder, a working deck, etc.

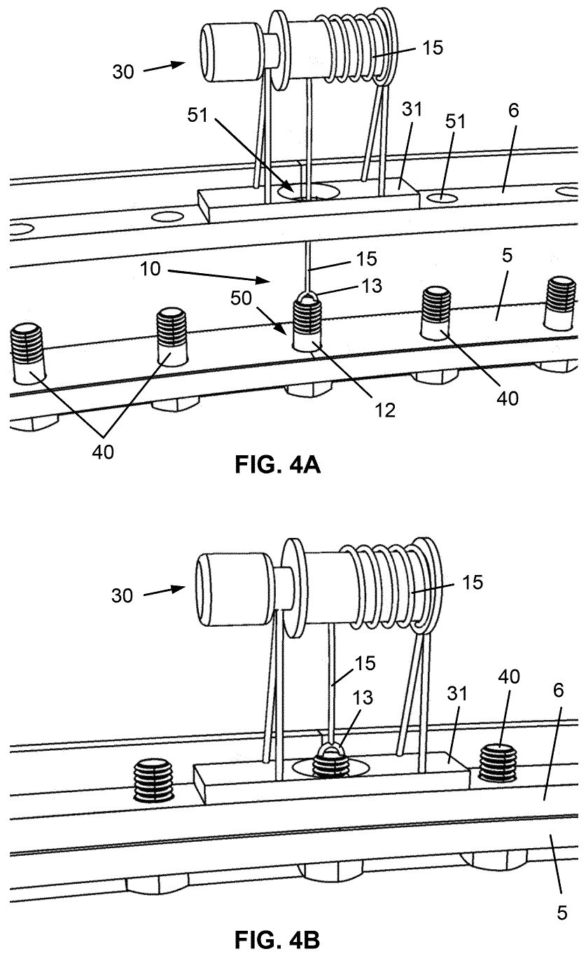

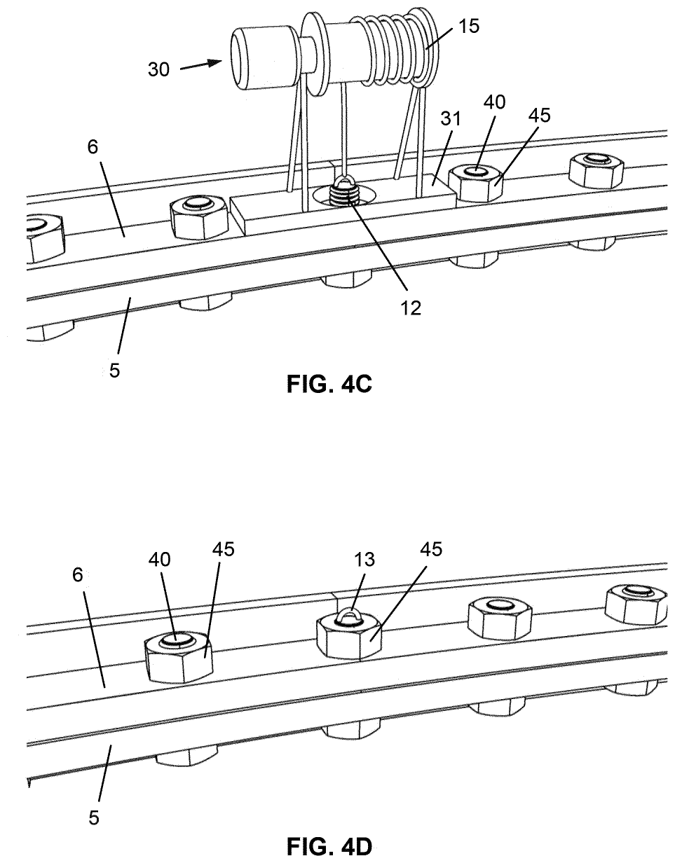

FIGS. 4A-4D show a device 10 and a method for mating the surfaces 5, 6 of two structures in accordance with embodiments.

The first surface 5 comprises a plurality of through holes 50, including the aforementioned first hole 50 where a first body 12 of the device 10 is introduced. The second surface 6 comprises a plurality of through holes 51, including the aforementioned second hole 51 where a second body 15 of the device 10 is introduced. In this example, the first surface 5 is a blade root whereas the second surface 6 is a surface belonging to a hub of a wind turbine.

The device 10 comprises the first body 12, which is similar to a bolt (like the bolts 40 in the through holes 50 of the first surface 5). The first body 12 is adapted to be mechanically coupled with the second body 15 by way of the member 13 that, in this embodiment, is a shackle. The first body 12 is inserted in the first hole 50 and protrudes from the other side thereof.

The device 10 comprises the second body 15, which is inserted in the second hole 51 and mechanically coupled with the first body 12, in particular the second body 15 has an end thereof attached to the member 13. In this case, the second body is not inserted in the first hole 50 owing to the presence of the first body 12 therein.

Again, the apparatus 30 is provided and attached to the second structure by way of the support 31. The second body 15 is arranged on the apparatus 30 so that a portion of the second body 15 is wound on the drum of the apparatus 30.

As seen in FIG. 4A, the first surface 5 is spaced apart from the second surface 6. In this example, the through holes 50, 51 of the first and second surfaces 5, 6 are substantially aligned, but in other examples they are not (for example, in the scenario of FIG. 1). By winding the second body 15, the first surface 5 (and, thus, the first structure) comes closer to the second surface 5 (and, thus, to the second structure) as illustrated in FIG. 4B. The first body 12 is, at the same time, inserted in the second hole 51.

While the distance between the surfaces 5, 6 is less than e.g. 5 centimeters, preferably less than 2 or 1 centimeters, and preferably is as close to 0 millimeters as possible, nuts 45 are arranged on the bolts 40 in other through holes 50, 51 for effecting the mating of the surfaces 5, 6. This is illustrated in FIG. 4C.

Turning to FIG. 4D, once the nuts 45 have been arranged on the bolts 40, the apparatus 30 and the second body 15 are both removed, and the first body 12 is kept inserted in both the first and second holes 50, 51, and a nut 45 is arranged thereon, thereby providing a bolted joint with the first body 12 of the device 10.

FIG. 5 shows mating of a blade 8 to a wind tower 1 in accordance with an embodiment.

A plurality of devices 10 is used for mating one of the blades 8 to, for example, a hub 9 of the wind tower 1.

A crane 90 with a boom lifts the blade 8 to be mated, and the devices 10 are provided between the blade 8 and the hub 9 so as to effect the mating between the surfaces of both the blade 8 and the hub 9.

Preferably, the devices 10 described with reference to FIGS. 4A-4D are used for mating the blade 8 to the hub 9 since the first body 12 can be reused as a bolted joint. Therefore, as part of the device is maintained on the structures, the mating is simpler than if the device had to be completely removed before providing a fastening device, for example.

FIGS. 6A-6C show mating of a blade 8 to a wind tower 1 in accordance with an embodiment.

In this embodiment, the blade 8 is first supported by a foldable frame 91 that has a first frame 92 and a second frame 93 mechanically coupled such that the first frame 92 can pivot and move relative to the second frame 93, as best seen in FIG. 6B. The foldable frame 91 preferably has wheels for movement thereof.

While supported on the foldable frame 91, a plurality of devices 10 is arranged in the blade 8 and hub 9 of the wind tower 1 so as to lift the blade 8 and effect the mating thereof to the hub 9.

By pulling the second body of the devices 10, for example by winding the second bodies by means of apparatus as the apparatus 30 described with reference to FIGS. 2A-2B and 4A-4D, the blade 8 is progressively lifted. At one point the blade 8 does not rest on the foldable frame 91 anymore as shown in FIG. 6C, then the foldable frame 91 can be removed and the second body of the devices 10 can be pulled further until it reaches the hub 9 and the mating is effected. Not only the distance between the two surfaces to be mated is reduced, but also any misalignment between the through holes of the two surfaces is also reduced and, at some point, the through holes become aligned thanks to the devices 10.

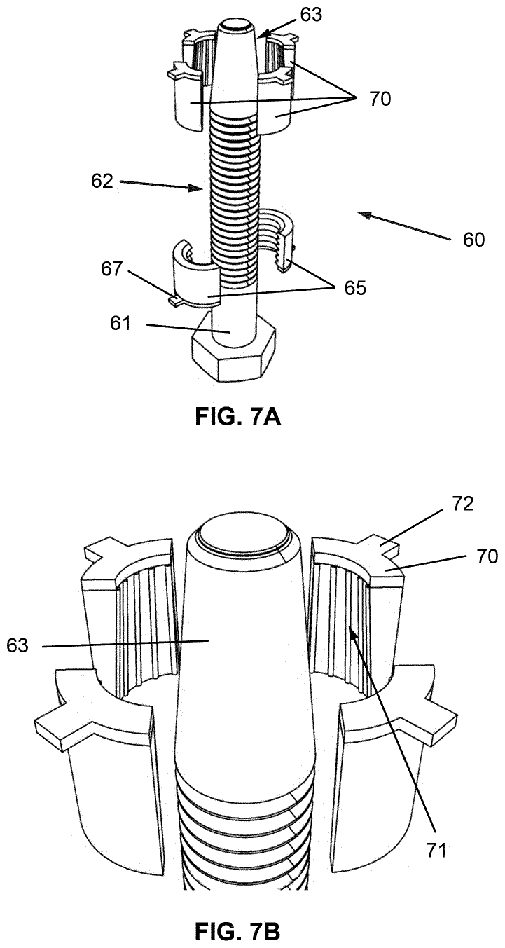

FIGS. 7A and 7B shows a device 60 for mating and/or demating the surfaces of two structures in accordance with an embodiment. The two structures may be, for instance but without limitation, two parts of a tower of a wind turbine (such as the one of FIG. 1), including an offshore wind turbine.

The device 60 comprises a first body 61, a second body 65, and means 70 for mechanically coupling the first body 61 with a first surface (not shown) such that the first body 61 is rotatable with respect to the first surface.

The first body 61 is similar to a bolt, and comprises a first portion 62 with a thread formed thereon, and a second portion 63 that is conical. The second body 65 is a nut that, in this embodiment, is comprised of two parts that are to be mechanically coupled for forming the nut. In other embodiments, the second body 65 is integrally formed, i.e. with a single part, or with more than two parts, e.g. three parts, four parts, etc. The provision of a plurality of parts may simplify the insertion of the second body 65 in a through hole of a surface. Moreover, the second body 65 preferably has an inner diameter that is between 0.5% and 5.0% smaller than an outer diameter of the first body 61 (at least of the first portion 62); in this way, when the first body 61 is inserted in the second body 65, the greater diameter of the first body 61 presses against the inner surface of the second body 65 and, consequently, compressing it against walls of the through hole where the second body 65 is inserted, thereby securing the second body 65 within the through hole.

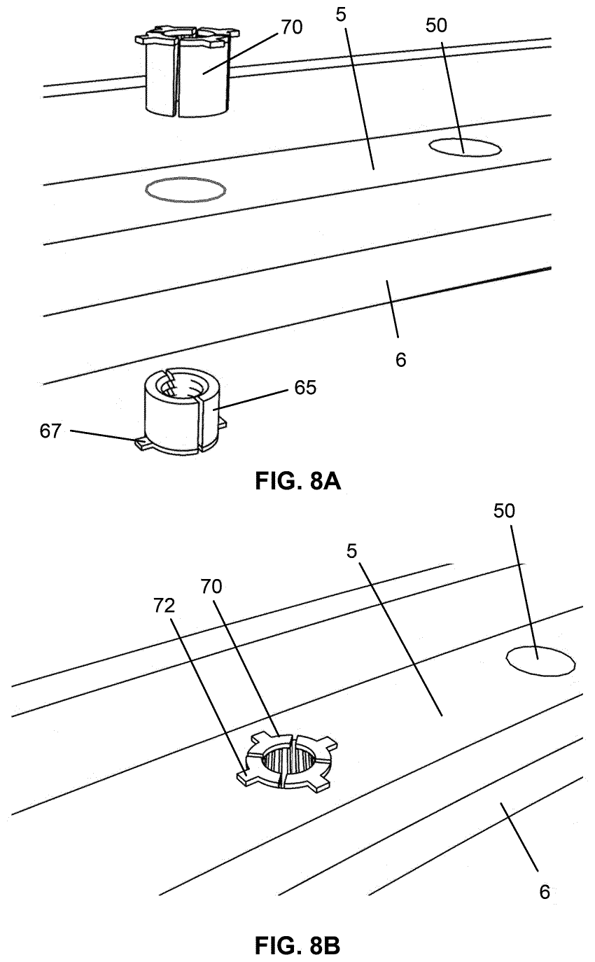

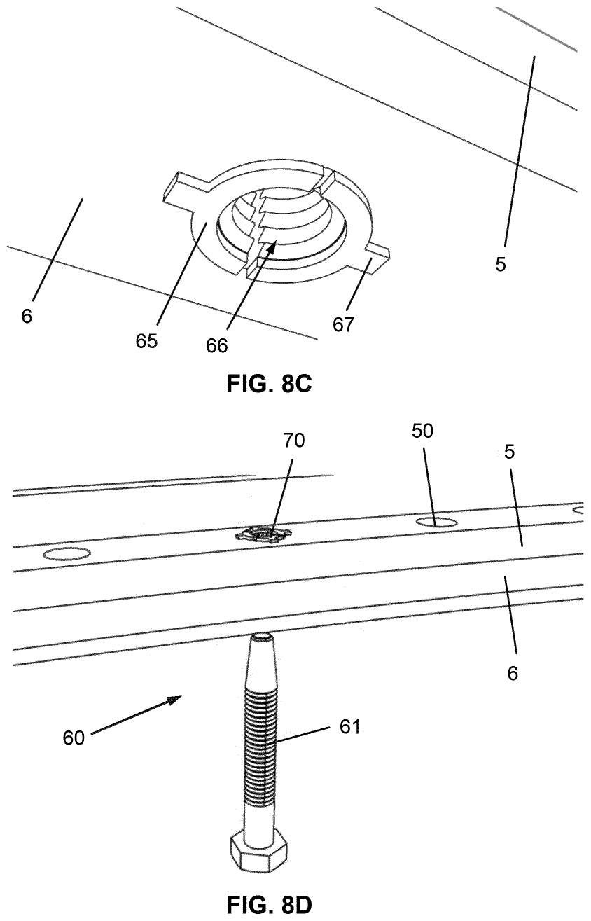

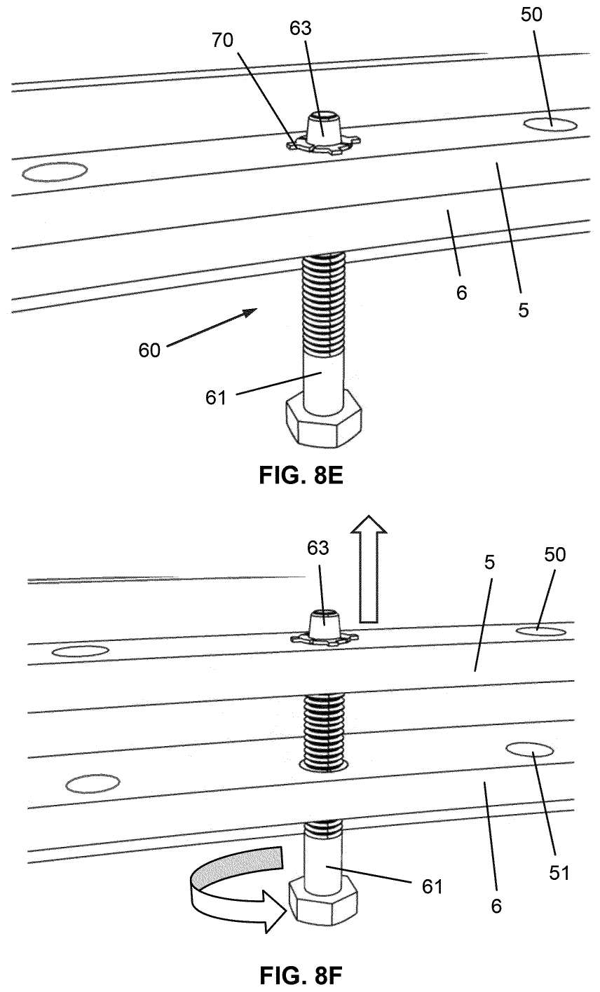

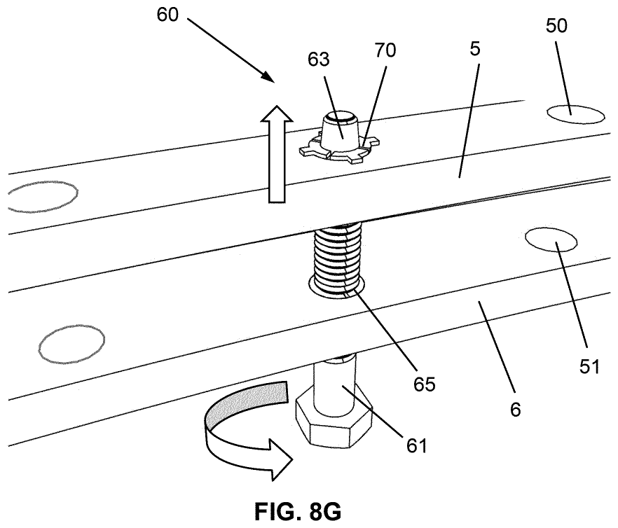

The first body 61 and the second body 65 form a screw mechanism in which the first body 61 operates as a screw in the mechanism by way of its first portion 62, and the second body 65 operates as a nut in the mechanism by way of threads 66 (as best seen in FIG. 8C) formed in an inner side thereof. The screw mechanism makes possible to change the distance between two surfaces so that they are more spaced apart or less space apart, depending on the relative rotation between the first body 61 and the second body 65, i.e. the direction of rotation of one with respect to the other.

The means 70 for mechanically coupling the first body 61 with the first surface are a rollers' mechanism formed by a plurality of parts adapted for insertion in a through hole of the first surface. When all the parts are coupled together, the cavity of the means 70 is conical so as to receive the second portion 63 of the first body 61. An inner side of these parts has ribs formed thereon for allowing rotation of the first body 61 (whenever mating or demating is to be effected) with respect to the first surface with reduced friction.

In other embodiments, and like the second body 65, the means 70 are formed by a single part, or by fewer parts than four, or more parts than four.

Preferably, the outer side of both the second body 65 and the means 70 (that is to say, the side to come into contact with walls of the through holes they are inserted in) has a material featuring a high friction coefficient so as to more reliably attach the second body 65 and the means 70 within the respective through holes.

The second body 65 (preferably each part thereof) and the means 70 (preferably each part thereof) both are preferably provided with respective flaps 67, 72 for easing manipulation thereof.

FIGS. 8A-8G show a method for mating the surfaces of two structures in accordance with an embodiment.

The method is carried out by means of a device 60 as described with reference to FIGS. 7A-7B.

In FIG. 8A is shown that the means 70 are to be attached to a through hole 50 of the first surface 5, hereinafter first hole 50, whereas the second body 65 is to be attached to a through hole 51 of the second surface 6, hereinafter second hole 51.

FIG. 8B shows the means 70 already inserted in the first hole 50 such that they form a cavity for receiving the first body 61 of the device 60. FIG. 8C shows the second body 65 already inserted in the second hole 51 such that it forms a cavity for receiving the first body 61 of the device 60; as seen in this figure, the second body 65 has threads 66 formed on the inside, which cooperate with the threaded portion 62 of the first body 61 so as to provide a screw mechanism.

FIG. 8D shows the first body 61 about to be introduced in the first and second holes 50, 51 through the second surface 6, that is to say, being first introduced in the second body 65. In those preferred embodiments in which the inner diameter of the second body 65 is smaller than the outer diameter of the first body 61, the first body 61 compresses the second body 65 against the sides of the second hole 51.

As shown in FIG. 8E, the second portion 63 of the first body 61 passes through the means 70 that are compressed against the sides of the first hole 50 due to the geometry and dimensions of both the second portion 63 and the means 63. This compression, in turn, mechanically couples the first body 61 with the first surface 5.

Upon rotating the first body 61 while inserted in the second body 65 and mechanically coupled with the first surface 5, the two surfaces 5, 6 become demated as illustratively represented in FIGS. 8F and 8G by way of arrows (indicating the movement of the surfaces 5, 6 and the rotation of the first body 61 relative to the second body 65). This is attained thanks to the second portion 63 and the cavity of the means 70 because the second portion 63 presses against the inner side of the means 70 (due to the geometry and dimensions thereof) and, accordingly, the means 70 exert a force on the first surface 5 for moving it away from the second surface 6.

When the surfaces 5, 6 space apart, the device 60 supports at least part of the weight of one of the structures. Therefore, depending on the mass of the structures, a plurality of such devices 60 may need be arranged in other through holes 50, 51 of the first and second surfaces 5, 6 for effecting demating while supporting the weight.

As it can be appreciated from the method illustrated in FIGS. 8A-8G, when the two surfaces 5, 6 are to be demated, it is rather complex to have a crane, for example, attached to one of the two surfaces 5, 6 (or structures thereof) for demating them due to the little or no separation at all between both surfaces 5, 6. In contrast, the device 60 uses the through holes 50, 51 of each surface 5, 6, which are intended to be used for the mating of the structures (thus, bolted joints are usually provided), to attach to the surfaces and demate them; accordingly, as the through holes 50, 51 are provided with bolted joints, one or several bolted joints are withdrawn from respective through holes 50, 51 so that one or more devices 60 can be arranged. After demating the surfaces 5, 6 (as in FIGS. 8F and 8G), thanks to the separation a crane may attach to one of the surfaces 5, 6 (or structures thereof) for then lifting said surface and move it.

In the embodiment illustrated in FIGS. 8A-8G, a demating procedure has been shown. With the same device(s) 60, however, a mating procedure may be effected as well. In this sense, reversing the process described in relation to these FIGS. 8A-8G, the first and second surfaces 5, 6 (and, thus, the first and second structures) become mated. In this respect, it is worth pointing out that again the problem with the attachment of e.g. a crane to a surface 5, 6 (or a structure thereof) exists because when the two surfaces 5, 6 are close together (a separation distance of e.g. 15 cm, 10 cm, etc.), the crane must detach the surface 5, 6 so that the two surfaces 5, 6 may come into contact, however there is still separation between the two surfaces 5, 6 when this occurs, so the weight of one of said structures is not supported by the crane anymore when mating is to be completed. Therefore, before the crane detaches the surface 5, 6, one or more devices 60 are inserted in respective first and second holes 50, 51 so that the device(s) 60 support/s the weight of one of the structures when the crane is detached, and then the mating process is completed thanks to the screw mechanism of the device(s) 60, which make possible to move surface 5, 6 towards the other by rotating the first body 61.

These problems are usually encountered by climbing cranes known in the art, thus the present method and device can be advantageously used in a mating or demating procedure involving a climbing crane.

Although not illustrated, in some embodiments, the second body 65 is part of the through hole 51 of the second surface 6. To this end, the through hole 51 has threads formed in an inner side thereof so that the first body 61 can be introduced in the through hole 51 and use the threads of the through hole 51 as the nut of the screw mechanism.

In this text, the terms first, second, third, etc. have been used herein to describe several devices, elements or parameters, it will be understood that the devices, elements or parameters should not be limited by these terms since the terms are only used to distinguish one device, element or parameter from another. For example, the first body could as well be named second body, and the second body could be named first body without departing from the scope of this disclosure.

In this text, the term “comprises” and its derivations (such as “comprising”, etc.) should not be understood in an excluding sense, that is, these terms should not be interpreted as excluding the possibility that what is described and defined may include further elements, steps, etc.

On the other hand, the invention is obviously not limited to the specific embodiment(s) described herein, but also encompasses any variations that may be considered by any person skilled in the art (for example, as regards the choice of materials, dimensions, components, configuration, etc.), within the general scope of the invention as defined in the claims.

1. A method for mating a first surface (5) of a first structure (3,4,8,9) to a second surface (6) of a second structure (3,4,8,9), each of the first and second surfaces (5,6) having a through hole (50,51) formed therein for receiving a bolt (40) or a guiding pin, the method comprising:
providing a device (10) at least comprising:
a first body (11,12) adapted for insertion at least in the through hole (50) of the first surface (5); and
a second body (15) adapted for insertion at least in the through hole (51) of the second surface (6), the first body (11,12) being further adapted for being mechanically coupled with a second body (15), and the second body (15) being mechanically coupled with the first body (11,12);
inserting at least a first portion of the first body (11,12) in the through hole (50) of the first surface (5);
inserting the second body (15) in the through hole (51) of the second surface (6) when the first and second surfaces (5,6) are spaced apart by a distance;
providing an apparatus (30) for winding the second body (15);
arranging the second body (15) on the apparatus (30); and
pulling one of the first and second structures (3,4,8,9) towards the other one of the first and second structures (3,4,8,9) by winding the second body (15) with the apparatus (30) while:
the first body (11,12) is at least inserted in the through hole (50) of the first surface (5);
the second body (15) is at least inserted in the through hole (51) of the second surface (6); and
the first and second surfaces (5,6) are spaced apart;
wherein the device (10) further comprises means for mechanically coupling either the first body (11,12) with the first surface (5) or the second body (15) with the second surface (6), and the means for mechanically coupling are:
one or more expanding bodies at least arranged on a perimeter of the first portion or the second body (15), the one or more expanding bodies being adapted to expand so as to exert a compressing force between the through hole (50) of the first surface (5) and at least the first portion of the device (10) or between the through hole (51) of the second surface (6) and the second body (15); and
adhesive arranged at least on the perimeter of the first portion or the second body (15).

2. The method of claim 1, further comprising:
removing the second body (15) from the second surface (6) after the pulling step; and
providing a fastening device after the step of withdrawing and when: both the first and second surfaces (5,6) are not spaced apart, and the through holes (50,51) thereof are aligned.

3. The method of any one of the preceding claims, wherein the pulling step is carried out additionally while the through holes (50,51) of the first and second surfaces (5,6) are not aligned.

4. The method of any one of the preceding claims, wherein the first body (11,12) is shaped such that it cannot be entirely pulled through the through hole (50) of the first surface (5) in a direction of insertion of the first body (11,12) in the through hole (50) of the first surface (5).

5. The method of any one of the preceding claims, wherein the first portion has a thread formed thereon, and the through hole (50) of the first surface (5) has a thread formed thereon.

6. The method of any one of the preceding claims, wherein at least an outer surface of the one or more expanding bodies is made of a high friction material.

7. The method of any one of the preceding claims, further comprising mechanically coupling the first body (11,12) with the second body (15) either prior to both inserting steps, or after both inserting steps.

8. The method of any one of the preceding claims, wherein the first structure (3,4,8,9) is suspended from a machine (90,91) during one or more of the following steps:
inserting at least the first portion of the first body (11,12) in the through hole (50) of the first surface (5);
inserting the second body (15) in the through hole (51) of the second surface (6);
arranging the second body (15) on the apparatus (30); and
pulling one of the first and second structures (3,4,8,9) towards the other one of the first and second structures (3,4,8,9).

9. The method of any one of the preceding claims, wherein each of the first and second structures (3,4) is a part (3,4) of a tower (2) of a wind turbine (1), one of said parts optionally being a nacelle of a wind turbine (1).

10. The method of any one of the preceding claims, wherein the first structure (8) is a rotor blade (8) of a wind turbine (1) and the second structure (9) is a hub (9) of a wind turbine (1).

11. The method of any one of the preceding claims, each of the first and second surfaces (5,6) has a plurality of through holes (50,51) formed therein for receiving a bolt (40) or a guiding pin, and the method further comprises:
providing a plurality of the devices (10);
inserting each device (10) of the plurality of the devices in a different through hole (50,51) of both the first and second surfaces (5,6);
providing a plurality of apparatuses (30) for winding the second body (15) of a device (10) of the plurality of devices; and
arranging the second body (15) of each device (10) of the plurality of devices on a different apparatus (30) of the plurality of apparatuses;
wherein pulling one of the first and second structures (3,4,8,9) towards the other one of the first and second structures (3,4,8,9) is carried out by winding the second body (15) of each device (10) of the plurality of devices with the plurality of apparatuses (30).

12. A device (10) for mating a first surface (5) of a first structure (3,4,8,9) to a second surface (6) of a second structure (3,4,8,9), the device (10) comprising:
a first body (11,12) at least having a first portion adapted for insertion at least in a through hole (50) of the first surface (5) for receiving a bolt (40) or a guiding pin;
a second body (15) adapted for insertion at least in a through hole (51) of the second surface (6) for receiving a bolt (40) or a guiding pin, the first body (11,12) being further adapted for being mechanically coupled with the second body (15), and the second body (15) being mechanically coupled with the first body (11,12); and
an apparatus (30) for winding the second body (15);
wherein the device (10) further comprises means for mechanically coupling either the first body (11,12) with the first surface (5) or the second body (15) with the second surface (6), and the means for mechanically coupling are:
one or more expanding bodies at least arranged on a perimeter of the first portion or the second body (15), the one or more expanding bodies being adapted to expand so as to exert a compressing force between the through hole (51) of the first surface (5) and at least the first portion of the device (10) or between the through hole (51) of the second surface (6) and the second body (15); and
adhesive arranged at least on the perimeter of the first portion or the second body (15).

13. The method of any one of claims 1-11, or the device (10) of claim 12, wherein the second body (15) is both elongated and flexible.

14. The method of any one of the claim 1-11 or 13, or the device (10) of any one of claims 12-13, wherein the first body (11,12) is a metallic body and the second body (15) is one of: a chain, a rope and a cable.
